(19) United States
(12) Patent Application Publication
(10) Pub. No.: US 2008/0303936 A1
(43) Pub. Date: Dec. 11, 2008

(54) CAMERA SYSTEM

(75) Inventors: Fumio Muramatsu, Kyoto (JP); Naoto Yumiki, Osaka (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Oasaka (JP)

(21) Appl. No.: 12/131,154

(22) Filed: Jun. 2, 2008

(30) Foreign Application Priority Data
Jun. 6, 2007 (JP) 2007-150197

(51) Int. Cl. H04N 5/225

(52) U.S. Cl. 348/335; 348/E05.024

(57) ABSTRACT

An image display control component 15 displays part of an image 82A as a reference image 82A′ on a liquid crystal monitor 16. Further, the image display control component 15 displays part of an image 82B acquired at a different aperture value from that of the image 82A as a comparative image 82B′ side by side the reference image 82A′ on the liquid crystal monitor 16. The comparative image 82B′ is a part whose position in the image 82B is the same as the position of the reference image 82A′ in the image 82A.

### CROSS-REFERENCE TO RELATED APPLICATIONS

This application claims priority to Japanese Patent Application No. JP2007-150197 filed on Jun. 6, 2007. The entire disclosure of Japanese Patent Application No. JP2007-150197 is hereby incorporated herein by reference.

### BACKGROUND OF THE INVENTION

1. Field of the Invention

The present invention relates to a camera system, and more particularly relates to a camera system with which a plurality of images can be displayed side by side.

2. Background Information

Digital still cameras with which an optical image of a subject is converted into an electrical signal have become tremendously popular in recent years. One of the features of a digital still camera is that the user captures an image while looking at a display device (such as a liquid crystal monitor for displaying images), and can check the captured image right away.

The images captured with a digital still camera vary with the photography conditions. For instance, the subject field depth can be changed, and the extent of background blur can be varied with the focal point on the subject, by varying the aperture value. To confirm a change in photography conditions, for example, a camera has been proposed in Japanese Laid-Open Patent Application No. JP2000-125153. With this camera, an image signal captured by opening the diaphragm and an image captured at a set aperture value are stored, part of one image is substituted for part of the other, and a combined display is shown on the display device.

Meanwhile, as discussed in Japanese Laid-Open Patent Application No. JP2003-345340, a camera has been proposed in which a plurality of different magnification rates are displayed on the display device for a single captured image.

However, with the camera discussed in the above-mentioned Japanese Laid-Open Patent Application No. JP2000-125153, comparing images is not easy because the plurality of images being compared are all images of different regions. Also, with the camera discussed in the above-mentioned JP2003-345340, a plurality of different images could not be compared at the same time. There has been a need for a camera that is more convenient in the comparison of a plurality of images.

### SUMMARY OF THE INVENTION

The present invention provides a camera system that improves convenience for the user by allowing a plurality of images to be displayed side by side.

The camera system, according to one aspect of the present invention, includes an imaging optical system for forming an optical image of a subject, an imaging component, a display component, and a display control component. The imaging component converts the optical image into an image signal and acquires an image of the subject. The display component allows a plurality of the images acquired by the imaging component to be displayed side by side. The display control component controls the display component to display as a reference image part of a first image acquired by the imaging component on the display component, and controls the display component to display as a comparative image part of a second image acquired by the imaging component under a different photography condition from that of the first image. The position of the comparative image in the second image is the same as the position of the reference image in the first image. The comparative image is proximate to the reference image on the display component.

With this camera system, the same portions of a plurality of images captured under different photography conditions can be compared side by side, making the images easier to compare. This improves convenience in the comparison of a plurality of images with this camera system.

The camera system, according to another aspect of the present invention, wherein the display control component controls the display component to display a first enlarged image obtained by enlarging part of the reference image, and a second enlarged image obtained by enlarging a part of the comparative image. The position of the second enlarged image in the comparative image is the same as the position of the first enlarged image in the reference image.

The camera system, according to yet another aspect of the present invention, wherein the display control component control the display component to display as a comparative image part of a third image acquired by the imaging component under a different photography condition from that of the first image and the second image. The position of the comparative image in the third image is the same as the position of the reference image in the first image.

The camera system, according to still another aspect of the present invention, wherein, the display component controls the display component to display a third enlarged image that is part of the third image when the first enlarged image is being displayed. The position of the third enlarged image in the comparative image is the same as the position of the first enlarged image in the reference image.

The camera system, according to a further aspect of the present invention, wherein the display control component controls the display component to display the photography conditions of the reference image and of the comparative image on the display component.

The camera system, according to still a further aspect of the present invention, wherein the photography condition is an aperture value.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a block diagram of a control system for an interchangeable lens unit and digital camera main body;

FIG. 2 is a concept diagram illustrating a viewfinder photography mode;

FIG. 3 is a concept diagram illustrating a monitor photography mode;

FIG. 4 is a top view of a camera system;

FIG. 5 is a rear view of a camera system;

FIG. 6 is a block diagram of a control system for the camera main body;

FIG. 7 is a block diagram of a control system for the interchangeable lens unit;

FIG. 8 is a concept diagram illustrating a folder used to record captured images;

FIG. 9 is a flowchart of a continuous photography mode;

FIG. 10 is a flowchart of a comparative reproduction mode;

FIG. 11 is a flowchart of a comparative reproduction mode (enlarged mode);

FIG. 12 is a diagram of a thumbnail display for selecting a series of images;

FIG. 13A is an example of the display during the operation of selecting a reference image;

FIG. 13B is an example of the display during the operation of selecting a reference image;

FIG. 14A is an example of the display during the operation of selecting a comparative image;

FIG. 14B is an example of the display during the operation of selecting a comparative image;

FIG. 15 is an example of the display during the operation of selecting a region to be enlarged;

FIG. 16 is an example of an enlarged display;

FIG. 17A is an example of the display during the operation of changing a comparative image in the course of image selection;

FIG. 17B is an example of the display during the operation of changing a comparative image in the course of image selection;

FIG. 18A is an example of the display during the operation of changing a comparative image in enlarged mode;

FIG. 18B is an example of the display during the operation of changing a comparative image in enlarged mode; and

FIG. 19 is an example of the display upon completion of comparative reproduction mode.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

1: Overall Configuration of Camera System

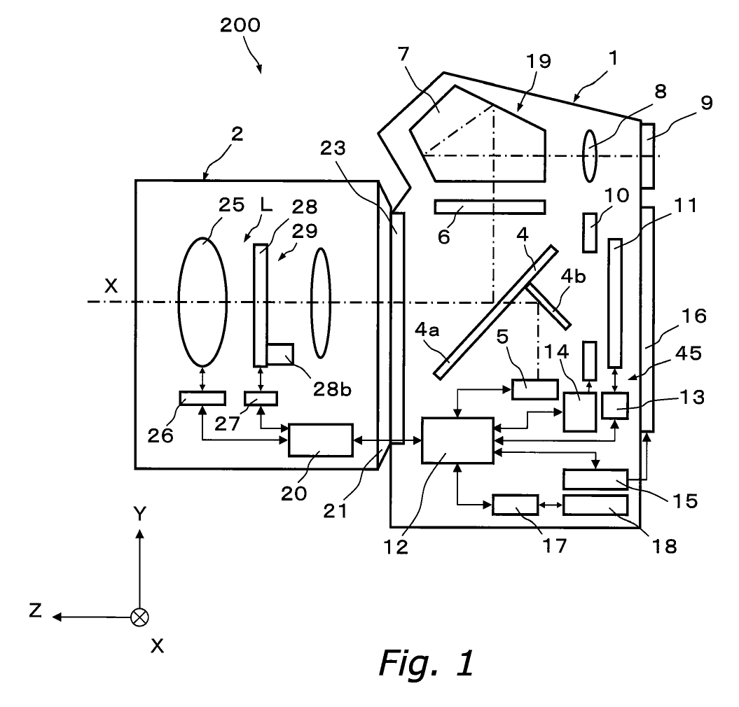

The camera system 200 pertaining to the present invention will be described. FIG. 1 is a diagram of the overall configuration of the camera system 200 pertaining to the present invention.

The camera system 200 shown in FIG. 1 is an interchangeable lens type of single-reflex digital camera system. The camera system 200 includes a camera main body 1 and an interchangeable lens unit 2.

The camera main body 1 and the interchangeable lens unit 2 exchange various control signals via an electrical contact (not shown) of a lens mount 21 on the interchangeable lens unit 2 side and an electrical contact (not shown) of a body mount 23 on the camera main body 1 side.

1.1: Configuration of Interchangeable Lens Unit

The interchangeable lens unit 2 mainly includes an imaging optical system L for forming an image of a subject on an imaging sensor 11 in the camera system 200, an aperture setting component 29 for adjusting the aperture of the imaging optical system L, and a lens microprocessor 20 for controlling various sequences of the interchangeable lens unit 2.

The interchangeable lens unit 2 has the lens mount 21 and is removably mounted to a body mount 23 provided to the body front face of the camera main body 1.

The lens microprocessor 20 is installed in the interchangeable lens unit 2 to control the various sequences of the interchangeable lens unit 2 and to hold various kinds of lens information. A focus controller 26 is mounted inside the interchangeable lens unit 2 for controlling the drive of a focus lens group 25. An aperture controller 27 for controlling an aperture unit 28 is also mounted.

The imaging optical system L mainly includes the focus lens group 25 and the aperture unit 28.

The aperture setting component 29 mainly includes an aperture ring 40 which the user can turn to input aperture values, an aperture linear sensor (not shown) for outputting a physical quantity according to the rotational angle of the aperture ring 40, an diaphragm drive motor 28b for driving diaphragm blades, and the aperture controller 27 for adjusting the aperture to be equal to the set aperture value.

The lens microprocessor 20 is a control device serving as the functional center of the interchangeable lens unit 2. The lens microprocessor 20 is also connected to various components mounted in the interchangeable lens unit 2 and controls various sequences of the interchangeable lens unit 2. For example, a CPU and a memory 69 are installed in the lens microprocessor 20 and various functions can be realized by having the CPU read programs stored in the memory 69. The lens microprocessor 20 outputs commands (such as control signals) to the focus controller 26, the aperture controller 27, a shift controller (not shown), and other devices in the camera system, and thereby executes control over the focus controller 26, the aperture controller 27, the shift controller (not shown), and the other devices. Also, the lens microprocessor 20 is connected via an interface with a body microprocessor 12 and communicates with this body microprocessor 12.

1.2: Configuration of Camera Main Body

The camera main body 1 generally includes a quick return mirror 4, a viewfinder optical system 19, a focus detection unit 5, a shutter unit 10, an imaging component, an image display component, a photography mode switching component, a depth of field reviewing mode setting component, a shutter controller 14, an image recorder 18, and the body microprocessor 12. The quick return mirror 4 varies the path taken by light from the subject. The viewfinder optical system 19 is used for viewing a subject image. The focus detection unit 5 is used for performing focus detection. The shutter unit 10 opens and closes the shutter. The imaging component is used for acquiring a subject image as a photographic image. The image display component is for displaying a photographic image. The photography mode switching component is used for switching between photography modes. The depth of field review setting component is for setting to depth of field reviewing mode. The shutter controller 14 controls the shutter unit 10, and the image recorder 18 records a photographic image. The body microprocessor 12 is used for controlling various sequences of the camera main body 1.

The viewfinder optical system 19 constitutes an observation optical system, the quick return mirror 4 constitutes a movable mirror, a photography mode switch button and the body microprocessor constitute the photography mode switching component, and a depth of field reviewing mode button and the body microprocessor constitute the depth of field reviewing mode setting component.

Subject light that has passed through the interchangeable lens unit 2 is split into two beams (reflected light beam and transmitted light beam) by a main mirror 4a of the quick return mirror 4, and the reflected beam is guided to the viewfinder optical system 19. The transmitted beam, meanwhile, is reflected by a sub-mirror 4b provided on the rear face side of the quick return mirror 4 and is utilized as an AF light beam for the focus detection unit 5. The focus detection unit 5 generally makes use of a phase difference detection method.

The light beam reflected by the main mirror 4a forms an image on a viewfinder screen 6. The subject image formed on the viewfinder screen 6 can be observed through a viewfinder eyepiece window 9 via a pentaprism 7 and an eyepiece 8.

The body microprocessor 12 that controls various sequences is installed in the camera main body 1. An imaging sensor controller 13 controls the drive of the imaging sensor 11. The shutter controller 14 controls the drive of the shutter unit 10. An image display controller 15 reads image data from the imaging sensor 11 and performs specific image processing, after which the photographic image is displayed on a liquid crystal monitor 16. An image recording controller 17 reads and writes photographic images through the image reader/recorder (hereinafter referred to as “image recorder 18”) from and to a recording medium such as an SD card (not shown).

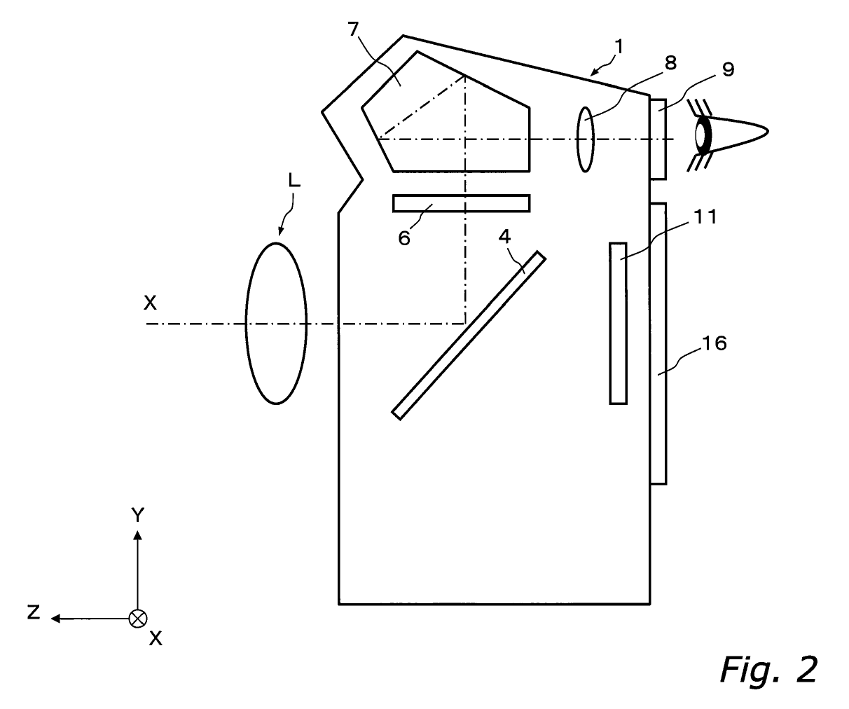

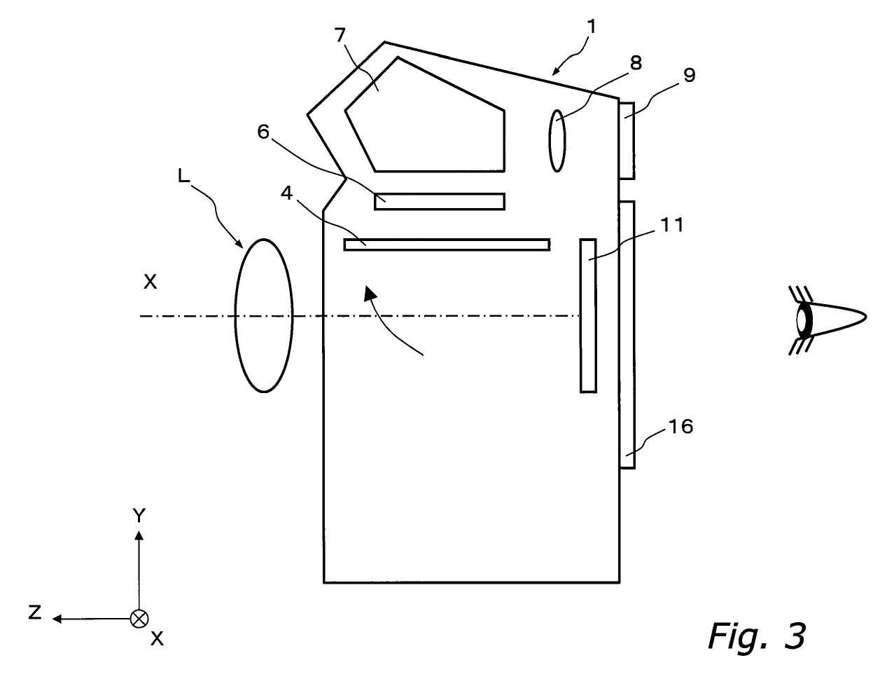

The quick return mirror 4 generally includes the main mirror 4a that is capable of reflecting and transmitting incident light, and a sub-mirror 4b that is provided on the rear face side of the main mirror 4a and reflects transmitted light from the main mirror 4a. The quick return mirror 4 can be flipped up outside the optical path X by a quick return mirror controller (not shown). The quick return mirror 4 is disposed so as to be movable between the position shown in FIG. 2 and the position shown in FIG. 3. Also, incident light is split into two beams by the main mirror 4a. The reflected beam is guided to the viewfinder optical system 19, while the transmitted beam is reflected by the sub-mirror 4b and guided to the focus detection unit 5.

The viewfinder optical system 19 mainly includes the viewfinder screen 6 where an image of the subject is formed, the pentaprism 7 for converting the subject image into an erect image, the eyepiece 8 for guiding the erect image of the subject to the viewfinder eyepiece window 9, and the viewfinder window 9 through which the user can see the subject.

The focus detection unit 5 is a unit for detecting whether or not an image formed by light from the subject is in a focused state (detecting focus) from the light reflected by the sub-mirror 4b and performs focus detection by a standard phase difference detection method, for example.

The imaging component 45 mainly includes the imaging sensor 11 (such as a CCD) for performing opto-electric conversion, and the imaging sensor controller 13 for controlling the imaging sensor 11, and acquires the subject image as a photographic image. The imaging component 45 converts the subject image produced by incident light into an electrical signal for forming a photographic image.

The image display component includes the liquid crystal monitor 16 (an example of the display component) and the image display controller 15 that controls the operation of the liquid crystal monitor 16. The liquid crystal monitor 16 has a display region including a first display region and a second display region and can display images acquired by the imaging component in an image display region 100. The image display controller 15 and the body microprocessor 12 realize a display controller which controls the liquid crystal monitor 16.

The image recorder 18 records and reproduces photographic images to and from a card-type recording medium (not shown), for example. The image recorder 18 is controlled by the image recording controller 17, which controls the operation of the image recorder 18.

The body microprocessor 12 is a control device serving as the functional center of the camera main body 1 and controls various sequences. The body microprocessor 12 is equipped with a CPU, ROM, and RAM, for example, and the body microprocessor 12 can perform many different functions when programs held in the ROM are read by the CPU. The body microprocessor 12 outputs commands (such as control signals) to the shutter controller 14, the imaging sensor controller 13, the image display controller 15, the image recording controller 17, and other devices in the camera system, and thereby executes control over the shutter controller 14, the imaging sensor controller 13, the image display controller 15, the image recording controller 17, and the other devices. Also, the body microprocessor 12 is connected via an interface with the lens microprocessor 20, and communicates with this lens microprocessor 20.

1.3: Viewfinder Photography Mode and Monitor Photography Mode

This camera system 200 has a viewfinder photography mode and monitor photography mode as its photography modes. The viewfinder photography mode is a mode in which the user looks through the viewfinder eyepiece window 9 to see the subject and is the ordinary photography mode for a conventional single-reflex camera.

In this viewfinder photography mode, as shown in FIG. 2, the quick return mirror 4 is disposed in a specific position in optical path X, and subject light is guided to the viewfinder optical system 19, so the user can see the subject image through the viewfinder eyepiece window 9. During actual photography, the quick return mirror 4 flips up outside the optical path X, and the shutter unit 10 is opened so that the subject image is formed on the imaging face of the imaging sensor 11.

The monitor photography mode is a mode in which the user takes a photo while looking at the subject displayed on the liquid crystal monitor 16. In the monitor photography mode, as shown in FIG. 3, the quick return mirror 4 is retracted from the optical path X. The subject image, or what is known as a through-image, is displayed on the liquid crystal monitor 16 via the imaging sensor 11.

1.4: Configuration of Interchangeable Lens Unit

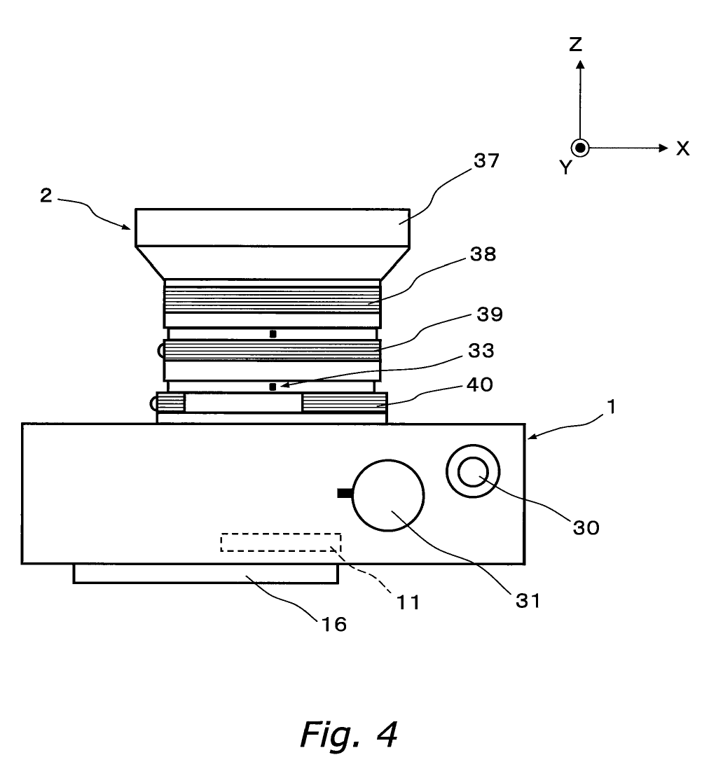

FIG. 4 is a top view of the camera system 200 to which has been attached the interchangeable lens unit 2 pertaining to this embodiment. The X, Y, and Z axes are defined as shown in FIG. 4. That is, the Z axis is defined as being parallel to the optical axis of the lenses constituting the imaging optical system L, the Y axis is defined as being parallel to the long-side direction of the captured images, and the X axis is defined as being parallel to the short-side direction of the captured images.

The camera system 200 has a housing that is held by the user when the subject is being photographed. This camera system 200 includes a release button 30 and a shutter speed setting dial 31.

The shutter speed setting dial 31 is a control member that is turned to set the shutter speed.

The camera main body 1 also includes the liquid crystal monitor 16. The liquid crystal monitor 16 is provided on the side of the camera main body 1 that faces the user. The operation of the liquid crystal monitor 16 will be described below.

The interchangeable lens unit 2 has a filter mount 37 on the side closest to the subject (the positive side in the Z axial direction). The interchangeable lens unit 2 has a zoom ring 38, a focus ring 39, and the aperture ring 40, in that order from the filter mount 37 toward the camera system 200 main body side (the negative direction of the Z axis). The zoom ring 38, focus ring 39, and aperture ring 40 are all cylindrical rotating control members, and are rotatably disposed around the outer peripheral face of the interchangeable lens unit 2.

1.5: Configuration of Rear Face of Camera Main Body

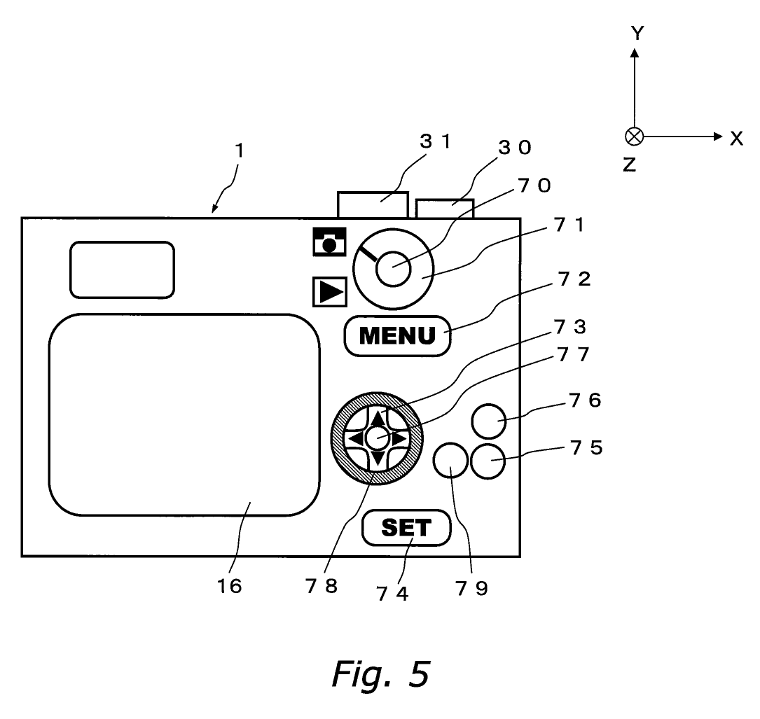

FIG. 5 is a rear view of the camera system 200 pertaining to this embodiment. The camera main body 1 includes a power button 70, a photography/reproduction mode switching lever 71, a menu button 72, a directional arrow key 73, a set button 74, and a depth of field reviewing button 76.

The power button 70 is a control member that is operated to turn the power on and off to the camera system 200. The photography/reproduction mode switching lever 71 is a control member that is operated to switch between a photography mode and a reproduction mode by switching a lever. The photography mode referred to here is a mode that is set to capture a new subject image and create an image signal with the camera system 200. The reproduction mode is a mode that is set to display an image signal already captured and stored in the camera system 200.

The menu button 72 is a control member that is operated to display various operation menus on the liquid crystal monitor 16. The directional arrow key 73 has up, down, left, and right arrow keys, and is a control member that is operated to select displayed categories from various operation menus. The set button 74 is a control member that is operated to set the display categories on various operation menus.

The depth of field reviewing button 76 is a button for changing to a depth of field reviewing mode, which is discussed below. With the camera system 200, the user presses this depth of field reviewing button 76 to change to depth of field reviewing mode.

1.6: Control System for Camera Main Body

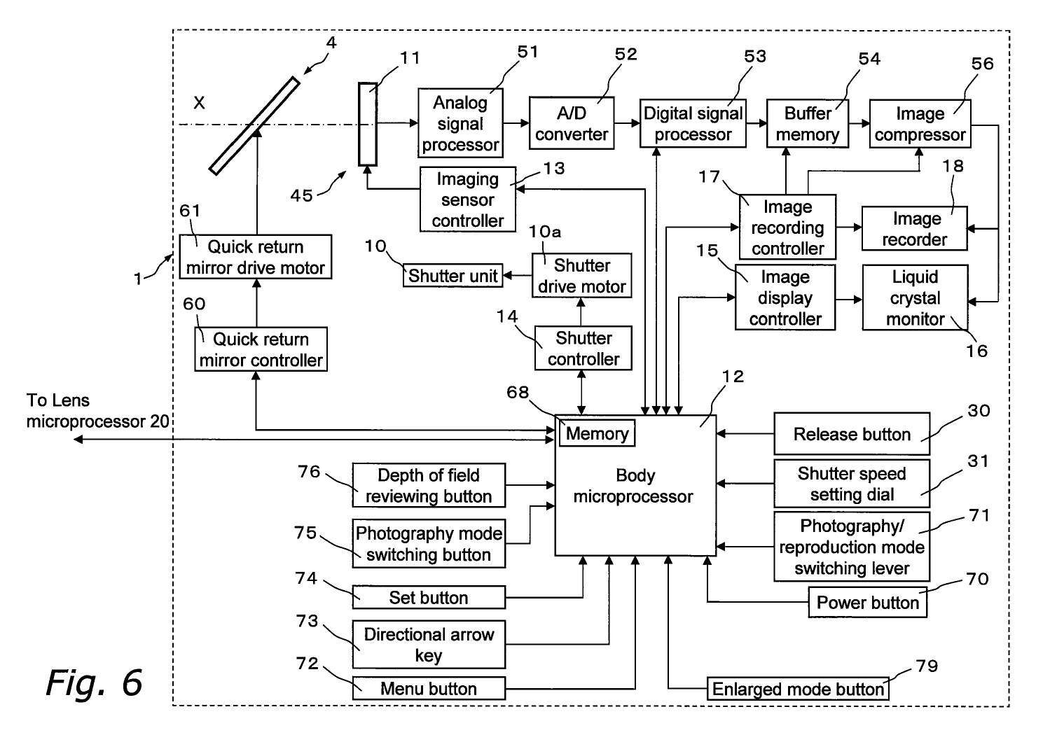

FIG. 6 is a block diagram of the control system of the camera main body 1 pertaining to this embodiment.

The body microprocessor 12 can receive signals from the release button 30, the shutter speed setting dial 31, the photography/reproduction mode switching lever 71, the menu button 72, the directional arrow key 73, the set button 74, a photography mode switching button 75, and the depth of field reviewing button 76. Also, the body microprocessor 12 can send signals to the shutter controller 14 and a quick return mirror controller 60. Furthermore, the body microprocessor 12 can perform bidirectional communication between the body microprocessor 12 and the image recording controller 17, bidirectional communication between the body microprocessor 12 and the image display controller 15, and bidirectional communication between the body microprocessor 12 and a digital signal processor 53. The body microprocessor 12 also has a memory 68 for storing signals.

The shutter controller 14 drives a shutter drive motor 10a on the basis of a control signal from the body microprocessor 12. The quick return mirror controller 60 drives a quick return mirror drive motor 61 on the basis of a control signal from the body microprocessor 12.

The release button 30 sends information indicating shutter timing to the body microprocessor 12. The shutter speed setting dial 31 sends set shutter speed information and shutter motor information.

The imaging sensor 11 is constituted by a CCD (charge coupled device) or the like. The imaging sensor 11 converts an optical image formed by the imaging optical system L of the interchangeable lens unit 2 into an electrical image signal. The drive of the imaging sensor 11 is controlled by the imaging sensor controller 13. The image signal outputted from the imaging sensor 11 is processed by an analog signal processor 51, an A/D converter 52, a digital signal processor 53, a buffer memory 54, and an image compressor 56, in that order.

An image signal is sent from the imaging sensor 11 to the analog signal processor 51. The analog signal processor 51 subjects the image signal outputted by the imaging sensor 11 to analog signal processing, such as gamma processing. The image signal outputted from the analog signal processor 51 is sent to the A/D converter 52. The A/D converter 52 converts the analog image signal outputted from the analog signal processor 51 into a digital signal.

The image signal outputted from the A/D converter 52 is sent to the digital signal processor 53. The digital signal processor 53 subjects the image signal converted into a digital signal by the A/D converter 52 to digital signal processing, such as noise elimination or contour enhancement. The image signal outputted from the digital signal processor 53 is sent to the buffer memory 54. The buffer memory 54 temporarily stores the image signal processed by the digital signal processor 53. The buffer memory 54 consists of a RAM (random access memory) or the like.

The image signal outputted from the buffer memory 54 is sent to the image compressor 56 according to a command from the image recording controller 17. The image compressor 56 subjects the image signal to compression processing according to a command from the image recording controller 17. The image signal is compressed to a data size that is smaller than that of the original data. The compression method can be, for example, JPEG (Joint Photographic Experts Group).

The compressed image signal is sent from the image compressor 56 to the image recorder 18 and the liquid crystal monitor 16. Meanwhile, the body microprocessor 12 sends a control signal to the image recording controller 17 and the image display controller 15. The image recording controller 17 controls the image recorder 18 on the basis of a control signal from the body microprocessor 12. The image display controller 15 controls the liquid crystal monitor 16 on the basis of a control signal from the body microprocessor 12.

The image recorder 18 records the image signal to an internal memory and/or removable memory on the basis of a command from the image recording controller 17. The image recorder 18 records information to be stored along with the image signal to an internal memory and/or removable memory on the basis of a command from the image recording controller 17. The information to be stored along with the image signal includes the date and time the image was captured, focal distance information, shutter speed information, aperture value information, and photography mode information.

The liquid crystal monitor 16 displays the image signal as a visible image on the basis of a command from the image display controller 15. The liquid crystal monitor 16 displays information to be displayed along with the image signal on the basis of a command from the image display controller 15. The information to be displayed along with the image signal includes focal distance information, shutter speed information, aperture value information, photography mode information, and focus state information.

Also, the liquid crystal monitor 16 displays a setting screen to be set by the user in a specific photography/reproduction mode on the basis of a command from the image display controller 15.

When the user captures an image, the power button 70 is switched on and the photography/reproduction mode switching lever 71 is put in the photography mode. This turns on the power to the camera system 200 main body, and an optical image of the subject which has been converted into an electrical image signal by the imaging sensor 11 is displayed as a visible image on the basis of a command from the image display controller 15.

When the camera system 200 is in its photography mode and the user presses the menu button 72, the liquid crystal monitor 16 displays the setting categories that can be changed by the user in photography mode as an iconized setting menu screen on the basis of a command from the image display controller 15.

1.7: Interchangeable Lens Unit Control System

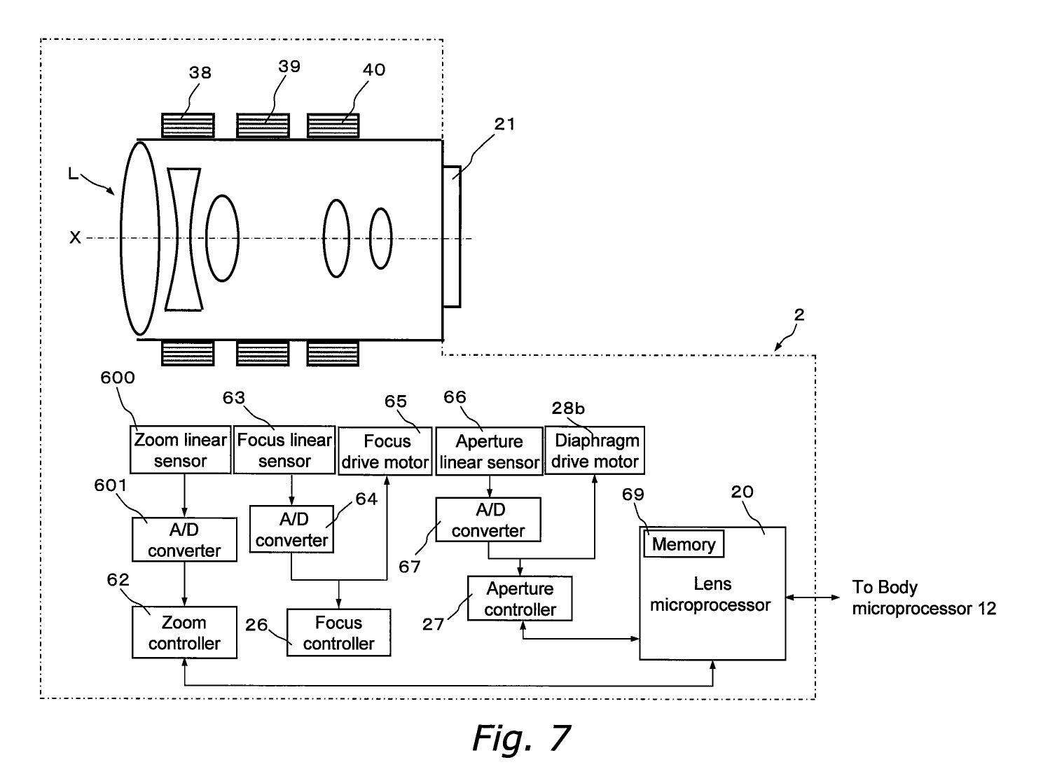

FIG. 7 is a block diagram of the control system inside the interchangeable lens unit 2 pertaining to an embodiment of the present invention.

The lens microprocessor 20 can perform bidirectional communication between the lens microprocessor 20 and a zoom controller 62, bidirectional communication between the lens microprocessor 20 and the focus controller 26, and bidirectional communication between the lens microprocessor 20 and the aperture controller 27.

The zoom controller 62 can receive signals from a zoom linear sensor 600 via an A/D converter 601. The zoom controller 62 converts the amount of rotation of the zoom ring 38 detected by the zoom linear sensor 600 into focal distance information about the imaging optical system L. The zoom controller 62 sends focal distance information to the lens microprocessor 20.

The focus controller 26 can receive signals from a focus linear sensor 63, and can send signals to a focus drive motor 65 via an A/D converter 64. The focus controller 26 determines the focus mode from the rotational angle of the focus ring 39, which is detected by the focus linear sensor 63 and digitized by the A/D converter 64. The focus controller 26 sends the result of this determination to the lens microprocessor 20. The focus controller 26 sends focal distance information detected from the rotational angle of the focus ring 39 to the lens microprocessor 20 on the basis of a command from the lens microprocessor 20. The focus controller 26 drives the focus drive motor 65 on the basis of a control signal from the lens microprocessor 20.

The aperture controller 27 can receive signals from the aperture linear sensor 66, and can send signals to the diaphragm drive motor 28b via the A/D converter 67. The aperture controller 27 determines the aperture mode from the rotational angle of the aperture ring 40, which is detected by the aperture linear sensor 66 and digitized by the A/D converter 67. The aperture controller 27 sends the result of this determination to the lens microprocessor 20. The aperture controller 27 sends aperture value information detected from the rotational angle of the aperture ring 40 to the lens microprocessor 20 on the basis of a command from the lens microprocessor 20. The aperture controller 27 drives the diaphragm drive motor 28b on the basis of a control signal from the lens microprocessor 20.

2: Operation of Camera System

2.1: Viewfinder Photography Mode

Next, the photographic operation of the camera system 200 will be described. First, the drive sequence in viewfinder photography mode, in which the user looks through the viewfinder eyepiece window 9, will be described through reference to FIGS. 1, 2, 6, and 7.

When the user presses the release button 30 halfway down, power is supplied to the body microprocessor 12 and the various units in the camera system 200. The body microprocessor 12 in the camera system 200, which is activated by the supply of power, receives various kinds of lens data from the lens microprocessor 20 in the interchangeable lens unit 2, which is also activated by the supply of power, via the lens mount 21 and the body mount 23, and stores this data in the built-in memory 68. Then, the body microprocessor 12 acquires the amount of defocus (hereinafter referred to as the Df amount) from the focus detection unit 5 and instructs the lens microprocessor 20 to drive the focus lens group 25 by this Df amount. The lens microprocessor 20 controls the focus controller 26 so as to operate the focus lens group 25 by the Df amount. While this focus detection and drive of the focus lens group 25 are repeated, the Df amount decreases, and at the point when the amount drops to or below a specific level, the body microprocessor 12 determines that focus has been achieved and halts the drive of the focus lens group 25.

After this, when the user presses the release button 30 all the way down, the body microprocessor 12 instructs the lens microprocessor 20 to adjust the aperture value to what has been calculated on the basis of the output from a light sensor (not shown). The lens microprocessor 20 controls the aperture controller 27 and the aperture is stopped-down to the designated aperture value. Simultaneously with the designation of the aperture value, the body microprocessor 12 uses the quick return mirror controller 60 to retract the quick return mirror 4 from within the optical path X. Upon completion of this retraction, the imaging sensor controller 13 instructs that the imaging sensor 11 be driven and instructs that the shutter unit 10 be operated. The imaging sensor controller 13 exposes the imaging sensor 11 for the length of time of the shutter speed calculated on the basis of the output from a light sensor (not shown).

Upon completion of this exposure, the imaging sensor controller 13 reads image data from the imaging sensor 11, and after undergoing specific image processing, this image data is displayed as a photographic image on the liquid crystal monitor 16. Also, image data that has been read from the imaging sensor 11 and has undergone specific image processing is written as image data to a storage medium via the image reader/recorder 18. Also, upon completion of the exposure, the quick return mirror 4 and the shutter unit 10 are reset to their initial positions. The body microprocessor 12 instructs the lens microprocessor 20 to reset the aperture to its open position, and the lens microprocessor 20 issues reset commands to the various units. Upon completion of this resetting, the lens microprocessor 20 notifies the body microprocessor 12 of the completion of resetting. The body microprocessor 12 waits for the completion of a series of processing after exposure and the reset completion information from the lens microprocessor 20, and then confirms that the release button has not been pressed, which concludes the imaging sequence.

2.2: Operation in Monitor Photography Mode

Next, the drive sequence in monitor photography mode, in which the user captures an image using the liquid crystal monitor 16, will be described through reference to FIGS. 1, 3, 6, and 7.

When the liquid crystal monitor 16 is used to capture an image, the user presses the photography mode switching button 75 to set the camera to monitor photography mode. When the camera is set to monitor photography mode, the body microprocessor 12 retracts the quick return mirror 4 from within the optical path X. As a result, light from the subject reaches the imaging sensor 11, so the imaging sensor 11 converts the light from the subject imaged on the imaging sensor 11 into image data, allowing it to be acquired and outputted as image data. The image data read from the imaging sensor 11 by the imaging sensor controller 13 is subjected to specific image processing, after which it is displayed as a photographic image on the liquid crystal monitor 16. Thus displaying the photographic image on the liquid crystal monitor 16 allows the user to follow the subject without looking through the viewfinder eyepiece window 9.

Next, the user presses the release button 30 halfway down, whereupon the body microprocessor 12 receives various kinds of lens data from the lens microprocessor 20 in the interchangeable lens unit 2 via the lens mount 21 and the body mount 23. This lens data is stored in the built-in memory 68. Then, the body microprocessor 12 uses the quick return mirror controller 60 to return the quick return mirror 4 to a specific position within the optical path X, thereby acquiring the Df amount from the focus detection unit 5 and instructing the lens microprocessor 20 to drive the focus lens group 25 by this Df amount. The lens microprocessor 20 controls the focus controller 26 so as to operate the focus lens group 25 by the Df amount. While this focus detection and drive of the focus lens group 25 are repeated, the Df amount decreases, and at the point when the amount drops to or below a specific level, the body microprocessor 12 determines that focus has been achieved and halts the drive of the focus lens group 25.

After this, when the user presses the release button 30 all the way down, the body microprocessor 12 instructs the lens microprocessor 20 to adjust the aperture value to what has been calculated on the basis of the output from a light sensor (not shown). The lens microprocessor 20 controls the aperture controller 27, and the aperture is stopped-down to the designated aperture value. Simultaneously with the designation of the aperture value, the body microprocessor 12 uses the quick return mirror controller 60 to retract the quick return mirror 4 from within the optical path X. Upon completion of this retraction, the imaging sensor controller 13 instructs that the imaging sensor 11 be driven and instructs that the shutter unit 10 be operated. The imaging sensor controller 13 exposes the imaging sensor 11 for the length of time of the shutter speed calculated on the basis of the output from a light sensor (not shown).

Upon completion of this exposure, the imaging sensor controller 13 reads image data from the imaging sensor 11, and after undergoing specific image processing, this image data is displayed as a photographic image on the liquid crystal monitor 16. Also, image data that has been read from the imaging sensor 11 and has undergone specific image processing is written as image data to a storage medium via the image reader/recorder 18. Also, upon completion of the exposure, the quick return mirror 4 and the shutter unit 10 are positioned in a state of being retracted from within the optical path X, so the user can then use the monitor photography mode to view the subject as a photographic image on the liquid crystal monitor 16.

When the monitor photography mode is to be canceled, the user presses the photography mode switching button 75 and changes back to the ordinary photography mode. That is, the viewfinder photography mode in which the user looks through the viewfinder eyepiece window 9 to capture an image. When the camera is changed back to viewfinder photography mode, the quick return mirror 4 is returned to a specific position within the optical path X. The quick return mirror 4 is also returned to a specific position within the optical path X when the power is shut off to the camera system 200 (such as a single-reflex digital camera) main body.

2.3: Exposure Setting Operation for Camera System

Next, the operation of setting the exposure for the camera system 200 will be described through reference to FIGS. 4 and 6. The camera system 200 has four exposure setting modes: a programmed photography mode in which exposure setting is performed automatically for an ordinary photographic region; a shutter speed preferential photography mode in which the shutter speed is set manually; an aperture preferential photography mode in which the aperture value is set manually; and a manual photography mode in which the shutter speed and aperture value are both set manually.

A user operating the camera system 200 can select among the four exposure setting modes by setting a combination of a specific rotational angle of the aperture ring 40 and the rotational angle of the shutter speed setting dial 31. Specifically, in a state in which the letter “A” on the aperture ring 40 lines up with the pointer 33, the user can set the camera to the programmed photography mode by putting the shutter speed setting dial 31 in the auto position. In a state in which the letter “A” on the aperture ring 40 lines up with the pointer 33, the user can set the camera to the shutter speed preferential photography mode by putting the shutter speed setting dial 31 in the manually settable position. In a state in which any of the numbers “2” to “11” on the aperture ring 40 lines up with the pointer 33, the user can set the camera to the aperture preferential photography mode by putting the shutter speed setting dial 31 in the auto position. In a state in which any of the numbers “2” to “11” on the aperture ring 40 lines up with the pointer 33, the user can set the camera to the manual photography mode by putting the shutter speed setting dial 31 in the manual position.

From here on, of these four exposure setting modes, the programmed photography mode and the shutter speed preferential photography mode will be collectively referred to as the auto aperture mode, and the aperture preferential photography mode and manual photography mode will be collectively referred to as the manual aperture mode.

2.4: Exposure Setting Operation in Auto Aperture Mode

The aperture linear sensor 66 outputs a signal corresponding to rotational angle to the aperture controller 27. When the letter “A” on the aperture ring 40 lines up with the pointer 33, and the user presses the release button 30, the aperture controller 27 determines that the exposure setting mode is the auto aperture mode on the basis of the signal received from the aperture linear sensor 66. The result of this determination is sent to the lens microprocessor 20 and the body microprocessor 12. Sending to the body microprocessor 12 is carried out via microprocessor communication between the lens microprocessor 20 and the body microprocessor 12.

Also, the shutter speed setting dial 31 outputs a signal corresponding to rotational angle to the body microprocessor 12. The body microprocessor 12 recognizes that the exposure setting mode is the auto aperture mode on the basis of the determination result received from the aperture controller 27 and the signal from the shutter speed setting dial 31.

The body microprocessor 12 sends a command to the digital signal processor 53. The digital signal processor 53 sends the body microprocessor 12 an image signal at a specific timing on the basis of the received command. The body microprocessor 12 computes an exposure value on the basis of the received image signal. If the exposure setting mode is the programmed photography mode, the body microprocessor 12 computes a suitable combination from the adjustable aperture value and shutter speed. If the exposure setting mode is the shutter speed preferential photography mode, the body microprocessor 12 computes a suitable aperture value for the set shutter speed.

The body microprocessor 12 produces a control signal on the basis of the computation result. The body microprocessor 12 sends a control signal based on the computed aperture value to the aperture controller 27 via the lens microprocessor 20 on the interchangeable lens unit 2 side. If the exposure setting mode is the programmed photography mode, the body microprocessor 12 sends a control signal based on the computed shutter speed to the shutter controller 14. If the exposure setting mode is the shutter speed preferential photography mode, the body microprocessor 12 sends the shutter controller 14 information about the shutter speed set by the shutter speed setting dial 31.

Also, the body microprocessor 12 sends a control signal to the image display controller 15. The image display controller 15 drives the liquid crystal monitor 16. When the content of the control signal designates the programmed photography mode, the liquid crystal monitor 16 gives a display indicating that the exposure setting mode is the programmed photography mode. When the content of the control signal designates the shutter speed preferential photography mode, the liquid crystal monitor 16 gives a display indicating that the exposure setting mode is the shutter speed preferential photography mode.

The aperture controller 27 produces a drive signal for driving the diaphragm drive motor 28b on the basis of a control signal from the lens microprocessor 20. The diaphragm drive motor 28b is driven on the basis of this drive signal. The drive of the diaphragm drive motor 28b results in the aperture blades being driven.

The shutter controller 14 produces a drive signal for driving the shutter drive motor 10a on the basis of a control signal from the body microprocessor 12. The shutter drive motor 10a is driven on the basis of this drive signal. The drive of the shutter drive motor 10a results in the shutter unit 10 being driven.

Exposure setting in the auto aperture mode of the camera system 200 is performed as discussed above. The above operation is executed instantly after the operation of the release button 30 by the user.

When imaging is complete, the body microprocessor 12 sends a control signal to the image recording controller 17. The image recorder 18 records an image signal to an internal memory and/or removable memory on the basis of a command from the image recording controller 17.

When the content of the control signal designates the programmed photography mode, the image recorder 18 records an image signal and information to an internal memory and/or removable memory on the basis of a command from the image recording controller 17 indicating that the exposure setting mode is the programmed photography mode. When the content of the control signal designates the shutter speed preferential photography mode, the image recorder 18 records an image signal and information to an internal memory and/or removable memory on the basis of a command from the image recording controller 17 indicating that the exposure setting mode is the shutter speed preferential photography mode.

2.5: Exposure Setting Operation in Manual Aperture Mode

Next, when the position of any of the numbers “2” to “11” on the aperture ring 40 lines up with the pointer 33, and the user presses the release button 30, the aperture controller 27 determines that the exposure setting mode is the manual aperture mode on the basis of the signal received from the aperture linear sensor 66. The result of this determination is sent to the lens microprocessor 20. Also, the shutter speed setting dial 31 outputs a signal corresponding to rotational angle to the body microprocessor 12.

The body microprocessor 12 recognizes that the exposure setting mode is the manual aperture mode on the basis of the determination result received from the aperture controller 27 and the signal from the shutter speed setting dial 31.

The lens microprocessor 20 requests the aperture controller 27 to provide aperture value information detected from the rotational angle of the aperture ring 40. The aperture controller 27 sends the aperture value information detected from the rotational angle of the aperture ring 40 on the basis of a command from the lens microprocessor 20 to the lens microprocessor 20 and the body microprocessor 12. Sending to the body microprocessor 12 is carried out via microprocessor communication between the lens microprocessor 20 and the body microprocessor 12. If the exposure setting mode is the aperture preferential photography mode, the body microprocessor 12 sends a command to the digital signal processor 53. The digital signal processor 53 sends an image signal to the body microprocessor 12 at a specific timing on the basis of the received command.

If the exposure setting mode is the aperture preferential photography mode, the body microprocessor 12 computes the shutter speed on the basis of the received image signal. If the exposure setting mode is the aperture preferential photography mode, the body microprocessor 12 computes a suitable shutter speed for the detected aperture value. If the exposure setting mode is the aperture preferential photography mode, the body microprocessor 12 produces a control signal on the basis of the computation result. If the exposure setting mode is the aperture preferential photography mode, the body microprocessor 12 sends a control signal based on the computed shutter speed to the shutter controller 14. If the exposure setting mode is the manual photography mode, the body microprocessor 12 sends information about the shutter speed set by the shutter speed setting dial 31 to the shutter controller 14.

Also, the body microprocessor 12 sends a control signal to the image display controller 15. The image display controller 15 drives the liquid crystal monitor 16. When the content of the control signal designates the aperture preferential photography mode, the liquid crystal monitor 16 indicates that the exposure setting mode is the aperture preferential photography mode. When the content of the control signal designates the manual photography mode, the liquid crystal monitor 16 indicates that the exposure setting mode is the manual photography mode.

The aperture controller 27 produces a drive signal for driving the diaphragm drive motor 28b on the basis of a control signal from the lens microprocessor 20. The diaphragm drive motor 28b is driven on the basis of this drive signal. The drive of the diaphragm drive motor 28b results in the aperture blades being driven. The shutter controller 14 produces a drive signal for driving the shutter drive motor 10a on the basis of a control signal from the body microprocessor 12. The shutter drive motor 10a is driven on the basis of this drive signal. The drive of the shutter drive motor 10a results in the shutter unit 10 being driven.

Exposure setting in the manual aperture mode of the camera system 200 is performed as discussed above. The above operation is executed instantly after the operation of the release button 30 by the user.

When imaging is complete, the body microprocessor 12 sends a control signal to the image recording controller 17. The image recorder 18 records an image signal to an internal memory and/or removable memory on the basis of a command from the image recording controller 17.

When the content of the control signal designates the aperture preferential mode, the image recorder 18 records an image signal and information to an internal memory and/or removable memory on the basis of a command from the image recording controller 17 indicating that the exposure setting mode is the aperture preferential mode. When the content of the control signal designates the manual photography mode, the image recorder 18 records an image signal and information to an internal memory and/or removable memory on the basis of a command from the image recording controller 17 indicating that the exposure setting mode is the manual photography mode.

2.6: Operation in Depth of Field Reviewing Mode

With this camera system 200, to determine the aperture value during imaging, a depth of field reviewing mode is further provided so that a plurality of images with different aperture values can be compared side by side.

The body microprocessor 12 of the camera system 200 determines whether or not the depth of field reviewing button 76 (FIG. 5) has been pressed. If the depth of field reviewing button 76 is pressed, the mode changes to depth of field reviewing mode. The depth of field reviewing mode will be described below in more specific terms.

When the depth of field reviewing button 76 is pressed, imaging is performed continuously at different aperture values. More specifically, the operation from step S1 to step S4 which will be described later is carried out. The continuously captured images are recorded in a folder 82.

The mode then changes to comparative reproduction mode. This change is made regardless of whether or not the comparative reproduction mode has been selected by operation of the photography/reproduction mode switching lever 71. The optimal image is then selected and set by user operation. More specifically, the operation from steps S103 to S118 which will be described later is carried out.

The actual aperture value is then set to the same aperture value as that of the image selected as the optimal image. More specifically, the body microprocessor 12 acquires the aperture value for the image selected as the optimal image from a file 182 recorded to the folder 82, and sends the acquired aperture value to the lens microprocessor 20. The lens microprocessor 20 outputs a command to the aperture controller 27 so that the actual aperture value will be set to the acquired aperture value. The aperture controller 27 drives the diaphragm drive motor 28b and sets the aperture to the appropriate aperture value state.

Then, the system moves to a photography stand-by state in the manual aperture mode in which the set aperture value is used, and the depth of field reviewing mode is concluded.

After this, the user can perform photography right away at the same aperture value as that of the optimal image selected by comparison of images in depth of field reviewing mode.

2.7: Operation in Continuous Imaging Mode

The drive sequence in continuous imaging mode, in which a plurality of images are continuously captured under varied photography conditions by a single operation of the release button 30, will be described through reference to FIGS. 1, 3, 6, and 7.

When the photography/reproduction mode switching lever 71 is turned to select the continuous imaging mode, the body microprocessor 12 is notified that the continuous imaging mode has been selected. Also, the body microprocessor 12 sends a control signal to the image display control component 15. The image display control component 15 drives the liquid crystal monitor 16 on the basis of this control signal. More specifically, the image display control component 15 displays on the liquid crystal monitor 16 an operating screen for selecting the photography condition under which continuous imaging will be performed.

The user uses the directional arrow key 73 to select a photography condition displayed on the operating screen, and presses the set button 74 to set the photography condition. The body microprocessor 12 determines the selected photography condition. Examples of photography conditions include image brightness, exposure value, and aperture value. The body microprocessor 12 continuously captures a plurality of images while the photography condition is varied. The plurality of images thus continuously captured will be referred to as a “series of images”. The user can also use the directional arrow key 73 to set the value of the condition to be changed, etc.

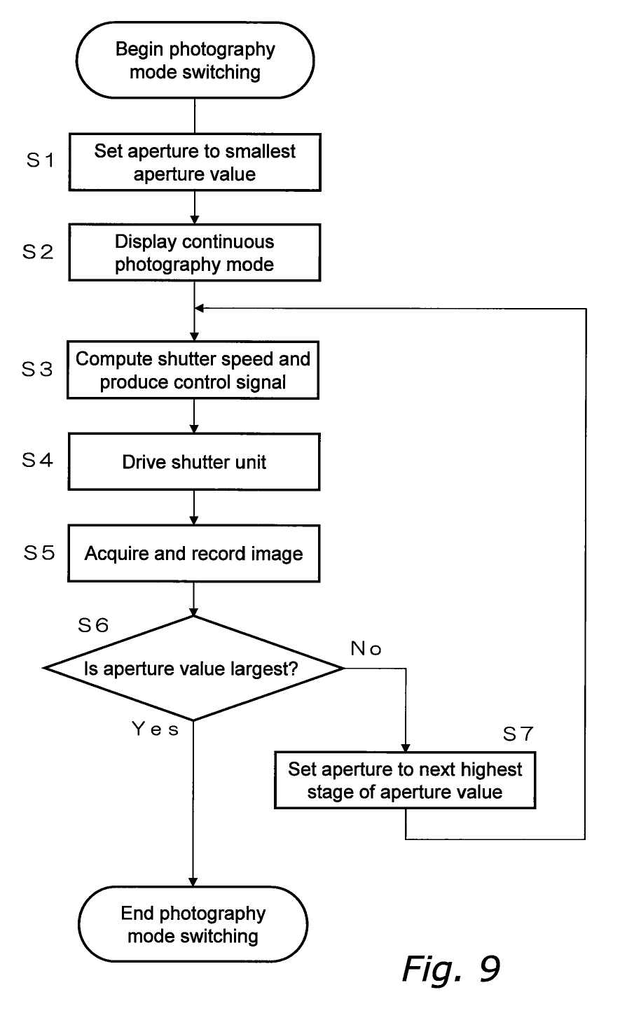

The operation in which the user changes the aperture value while continuous imaging is performed will now be described through reference to FIG. 9 as an example of continuous imaging.

When aperture value is selected as the photography condition, the body microprocessor 12 sends a command to the lens microprocessor 20 to set the aperture value to the smallest aperture value that can be set (such as F2), regardless of the aperture value that has been set by the aperture ring 40 (step S1).

Also, the body microprocessor 12 sends a control signal to the image display control component 15. The image display control component 15 drives the liquid crystal monitor 16 on the basis of this control signal. More specifically, when the content of the control signal designates continuous imaging mode by change in aperture value, the image display control component 15 displays on the liquid crystal monitor 16 that the mode is continuous imaging mode by change in aperture value (step S2).

The same imaging operation as when the user presses the release button 30 all the way down and then the exposure setting mode is the aperture preferential photography mode (discussed above) is repeated, with the aperture value being increased by one stage at a time from the smallest value. The operation after the release button 30 is pressed all the way down will now be described in specific terms.

The body microprocessor 12 computes a suitable shutter speed for the aperture value received from the lens microprocessor 20, and produces a control signal on the basis of this computation result. The body microprocessor 12 sends this control signal to the shutter controller 14 (step S3).

The aperture controller 27 produces a drive signal for driving the diaphragm drive motor 28b on the basis of a control signal from the lens microprocessor 20. The diaphragm drive motor 28b drives the aperture blades on the basis of this drive signal. The shutter controller 14 produces a drive signal for driving the shutter drive motor 10a on the basis of a control signal from the body microprocessor 12. The shutter drive motor 10a drives the shutter unit 10 on the basis of this control signal (step S4).

A single image is captured under the set photography condition. When the imaging is complete, the body microprocessor 12 sends a control signal to the image recording controller 17. The image recorder 18 records an image signal to an internal memory and/or removable memory on the basis of a command from the image recording controller 17 (step S5).

If the aperture value during the previous imaging was the maximum value, the body microprocessor 12 concludes the imaging operation (step S6). If the aperture value during the previous imaging was not the maximum value, the body microprocessor 12 commands the lens microprocessor 20 to set the aperture value one stage higher (steps S6 and S7). The lens microprocessor 20 sets the aperture value at this command, and the operation from step S3 to step S5 is carried out by the body microprocessor 12. The operation from step S3 to step S5 is repeated until the aperture value reaches its maximum.

How to change the aperture value is not limited to changing it one stage at a time from the minimum to maximum value, and other methods that are possible include changing it two stages at a time, and changing it from the maximum to minimum value.

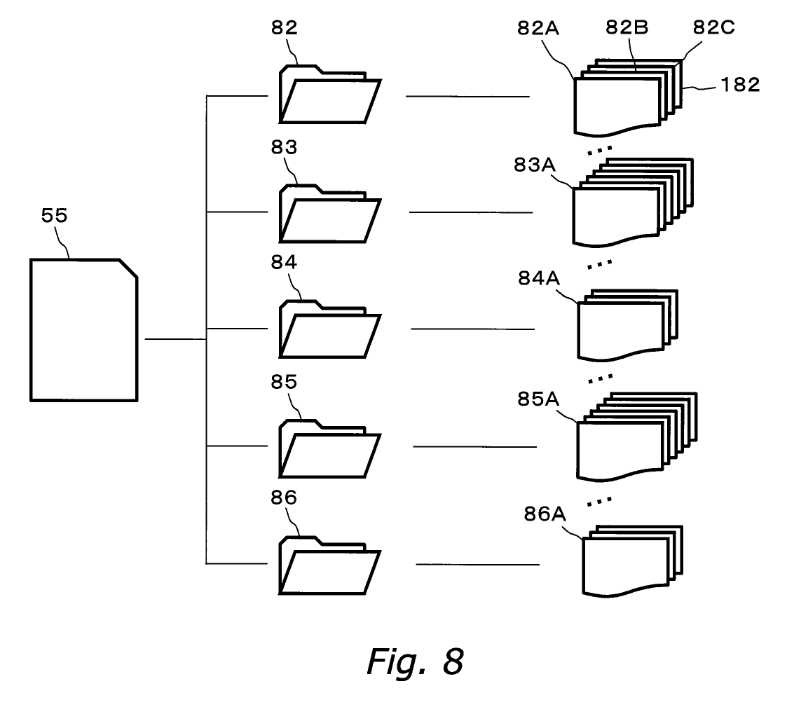

FIG. 8 shows the folder structure when a series of captured images are recorded to an SD card or other such recording medium 55. Every time the user captures a series of images, a folder is created under the recording medium 55 The folders 82 to 86 correspond to continuous imaging for a total of five times. At the same time, the body microprocessor 12 stores all of the series of images in folders (in the case of the folder 82, for example, images 82A, 82B, and 82C). Further, the body microprocessor 12 also stores a file 182 including information related to photography conditions, for example, in the folder 82. Information about the photography condition changed in the acquiring of the series of images 82A to 82C stored in a single folder 82, and the values of the photography condition for images 82A to 82C, are recorded in the file 182. For instance, of the series of images 82A to 82C, the aperture value of the image 82A is F2, the aperture value of the image 82B is F5.6, and the aperture value of the image 82C is F8. The images 82A, 82B, and 82C are examples of the first image, second image, and third image.

2.8: Operation in Comparative Reproduction Mode

Since the user selects the optimal image from among a plurality of images (a series of images) that have been continuously captured, the operation of the comparative reproduction mode, in which a plurality of images are displayed for comparison, will be described.

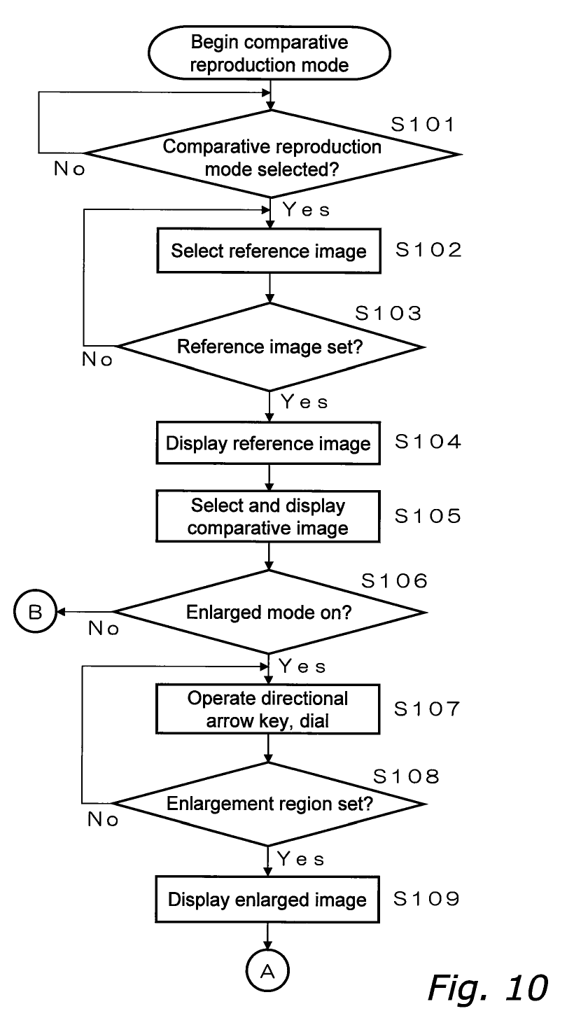

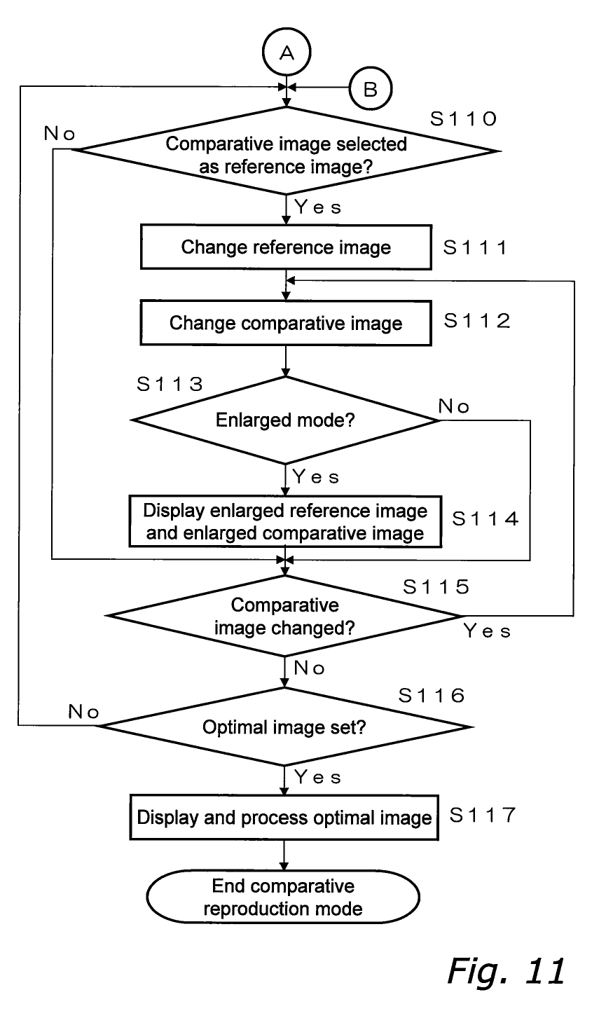

FIGS. 10 and 11 are flowcharts illustrating the operation in comparative reproduction mode. The body microprocessor 12 determines whether or not the comparative reproduction mode has been selected with the photography/reproduction mode switching lever 71 (step S101). If the comparative reproduction mode has been selected, the mode changes to comparative reproduction mode.

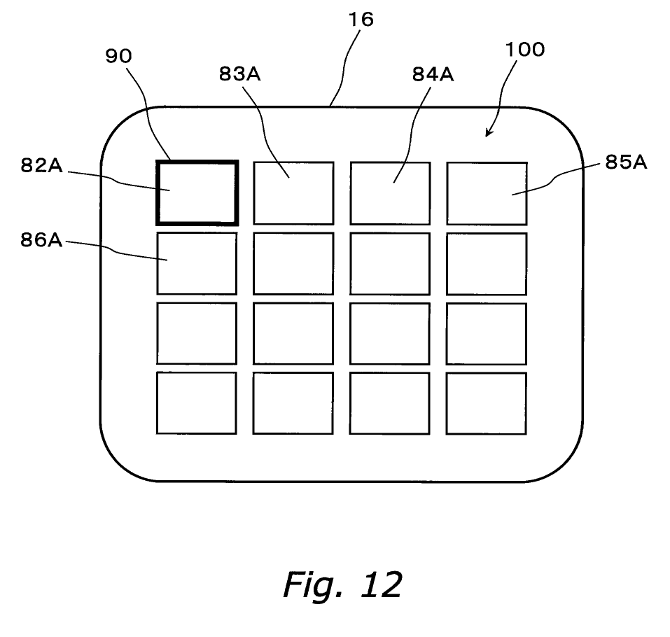

In the comparative reproduction mode, first a reference image that serves as a reference in comparing images is selected. More specifically, as shown in FIG. 12, when the comparative reproduction mode is entered, the image display control component 15 displays a thumbnail view of one representative image from each folder. The user uses the directional arrow key 73 to put a cursor frame 90 around the desired thumbnail image and select that image from among the plurality of thumbnail images displayed in FIG. 12. When a set button 77 is pressed in this state, this selects the series of images from which the optimal image is to be selected.

When the user selects the thumbnail image 82A from among the thumbnail images shown in FIG. 12, the body microprocessor 12 proceeds to the stage at which the user selects the optimal image from the series of images in the folder 82 in which the image 82A is stored.

More specifically, the image display control component 15 displays the image 82A on the liquid crystal monitor 16. The display region of the liquid crystal monitor 16 is divided into two parts, for example, and the cursor frame 90 is displayed on one side of the region that has been divided in two.

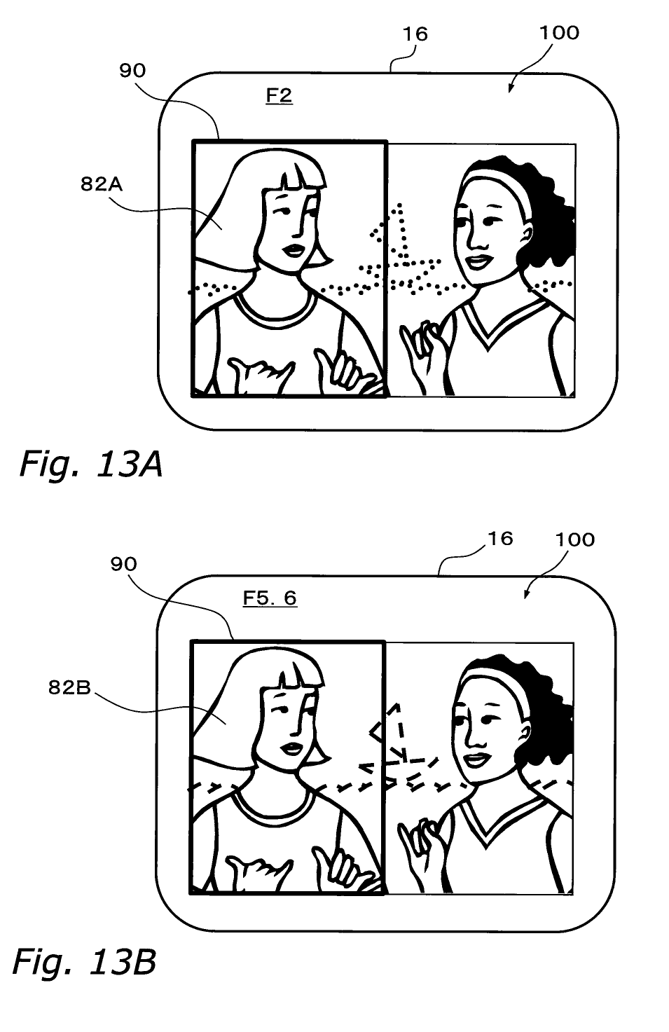

Next, the user turns a dial 78 to select an image that serve as a reference from among the series of images recorded to the folder 82. Examples of the display at this point are shown in FIGS. 13A and 13B. First, as in the display example shown in FIG. 13A, the image 82A, whose aperture value is F2, is displayed. When the dial 78 is turned one step to the right, the image 82B, whose aperture value is F5.6, which is the next larger aperture value after that of the image 82A, is displayed, as in the display example shown in FIG. 13B. When the dial 78 is turned one step to the left, the image 82A in this state, whose aperture value is F2, which is the next smaller aperture value after that of the image 82B, is displayed, as in the display example shown in FIG. 13A. Thus, the image that will serve as a reference can be selected by turning the dial 78.

After the image to be used as a reference has been selected by operation of the dial 78, the directional arrow key 73 is operated to move the cursor frame 90 to the left or right half of the image, and select one or the other as the reference image (step S102).

After this, the reference image is set by pressing the set button 77 (step S103). A case will now be described in which the left half of the image 82A, whose aperture value is F2 (reference image 82A′), is selected as the reference image.

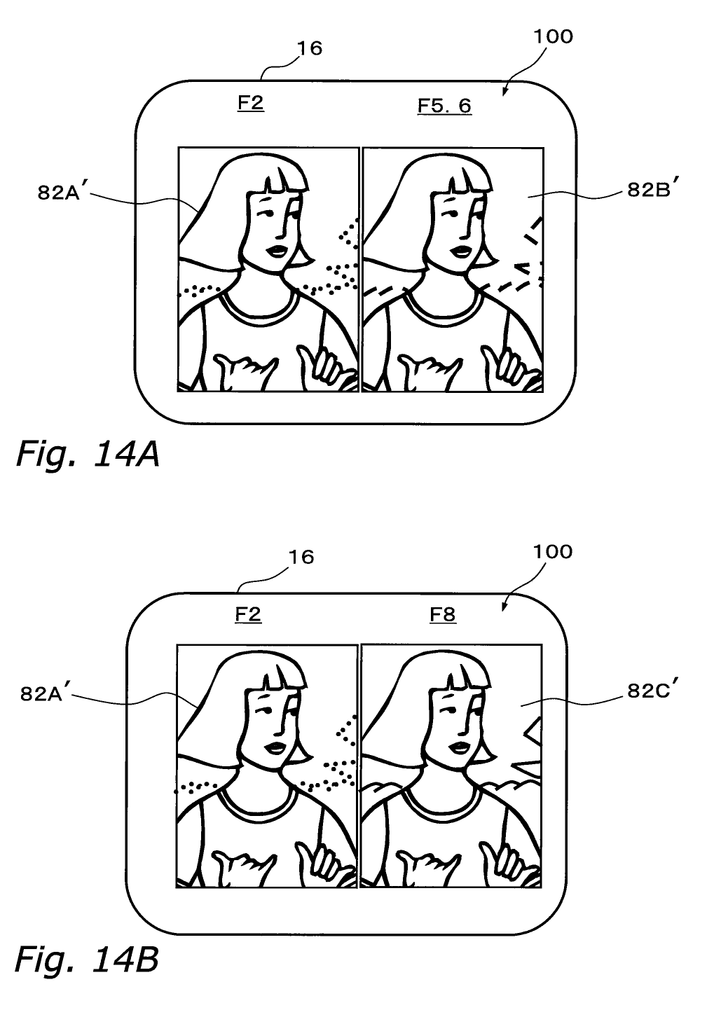

The image display control component 15 displays the reference image 82A′ on one side of the liquid crystal monitor 16 (step S104). Then, the image display control component 15 displays a comparative image on the side of the liquid crystal monitor 16 on which the reference image 82A′ is not displayed (such as the right side in FIG. 14A). More specifically, the image display control component 15 selects one image (such as the image 82B or 82C) that is different from the image 82A from among the images stored in the folder 82 in which the image 82A including the reference image 82A′ has been recorded. A portion in which the position in the selected image is the same as the position of the reference image 82A′ in the image 82A (more specifically, the left-half image selected with the cursor frame 90) is displayed as a comparative image on the right half of the liquid crystal monitor 16. In this embodiment, the left-half image of the image 82B acquired at an aperture value of F5.6, which is the next largest after that of the image 82A, is displayed as a comparative image 82B′ on the right half of the liquid crystal monitor 16. Thus, of the plurality of images with different photography conditions, two images in the same respective regions are displayed side by side as a reference image and a comparative image on the liquid crystal monitor 16.

Next, the user turns the dial 78 to select a comparative image from among images other than the image 82A including the reference image 82A′, out of the series of images recorded to the folder 82. The selected comparative image is displayed on the liquid crystal monitor 16 (step S105). FIGS. 14A and 14B show examples of the display here. As with the display example shown in FIG. 14A, the reference image 82A′ (the left half of the image 82A, whose aperture value is F2) is displayed on the left side of the display region of the liquid crystal monitor 16, while the comparative image 82B′ (the left half of the image 82B, whose aperture value is F5.6) is displayed on the right side of the display region of the liquid crystal monitor 16. When the dial 78 is turned by one step to the right, as shown in FIG. 14B, an image 82C′ that is the left half of the image 82C acquired at an aperture value of F8, which is the next largest after the comparative image 82B′ displayed prior to the operation of the dial 78, is displayed as a comparative image on the right side of the display region of the liquid crystal monitor 16. Also, when the dial 78 is turned by one step of the left, as shown in FIG. 14A, an image 82B′ that is the left half of the image 82B acquired at an aperture value of F5.6, which is the next smallest after the comparative image 82C′ displayed prior to the operation of the dial 78, is displayed on the right side of the display region of the liquid crystal monitor 16. Thus, by turning the dial 78, the comparative image on the right side can be updated and displayed while maintaining the state in which the reference image 82A′ is displayed on the left side of the display region of the liquid crystal monitor 16.

At this point, out of the contents of the file 82Z, the body microprocessor 12 can ascertain that the reference image and the comparative image are both images with changed aperture values, and the aperture value of each. The image display control component 15 displays the aperture values of the reference image and the comparative image on the liquid crystal monitor 16 based on the above information.

Here, in selecting either the reference image or the comparative image, if the user wishes to compare enlarged images of the selected portions of the two images, he presses an enlarged mode button 79. The body microprocessor 12 determines whether or not the enlarged mode button 79 has been pressed (step S106). If the enlarged mode button 79 is pressed, the mode changes to enlarged mode.

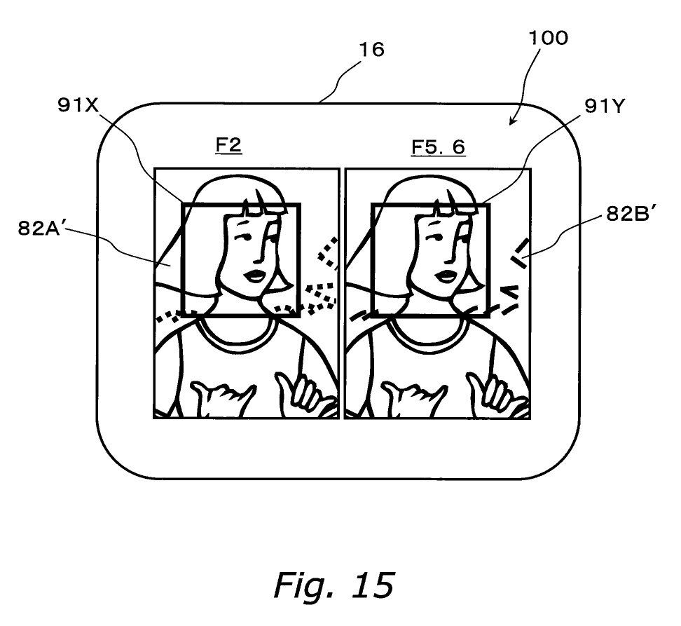

In the enlarged mode, the user can select the places in the reference image and comparative image to be enlarged (the enlargement regions) by pressing the directional arrow key 73. Also, the user can set the display magnification by turning the dial 78 (step S107). FIG. 15 shows an example of this display.

When the enlarged mode button 79 is pressed, two enlargement cursor frames 91X and 91Y, which show the same regions of the reference image 82A′ and the comparative image 82B′, respectively, are displayed in addition to the last display from step S105 (the display example shown in FIG. 14a). More specifically, the position of the enlargement cursor frame 91X in the reference image 82A′ is the same as the position of the enlargement cursor frame 91Y in the comparative image 82B′. When the user operates the directional arrow key 73 up, down, left, or right, the enlargement cursor frames 91X and 91Y move by a distance corresponding to the operation amount in the direction in putted to the directional arrow key 73. Therefore, during or after movement, the positional relationship between the reference image 82A′ and the enlargement cursor frame 91X is the same as the positional relationship between the comparative image 82B′ and the enlargement cursor frame 91Y.

When the user turns the dial 78, the size of the enlargement cursor frames 91X and 91Y changes according to the direction and amount the dial 78 was turned. Therefore, during or after the size is changed, the positional relationship between the reference image 82A′ and the enlargement cursor frame 91X is the same as the positional relationship between the comparative image 82B′ and the enlargement cursor frame 91Y. The regions bounded by the enlargement cursor frames 91X and 91Y are selected as the enlargement regions.

Thus, the same respective regions of the reference image 82A′ and the comparative image 82B′ are selected in synchronization. In this embodiment, the range of the enlargement region with respect to the total range of the reference image is the same as the range of the enlargement region with respect to the total range of the comparative image.

When the user presses the set button 77, the enlargement regions are set (step S108). In the enlarged display discussed below, the enlarged display regions are constant, regardless of the size of the enlargement regions, so setting the size of the enlargement regions simultaneously results in the enlargement magnification being set by the image display control component 15 (step S108).

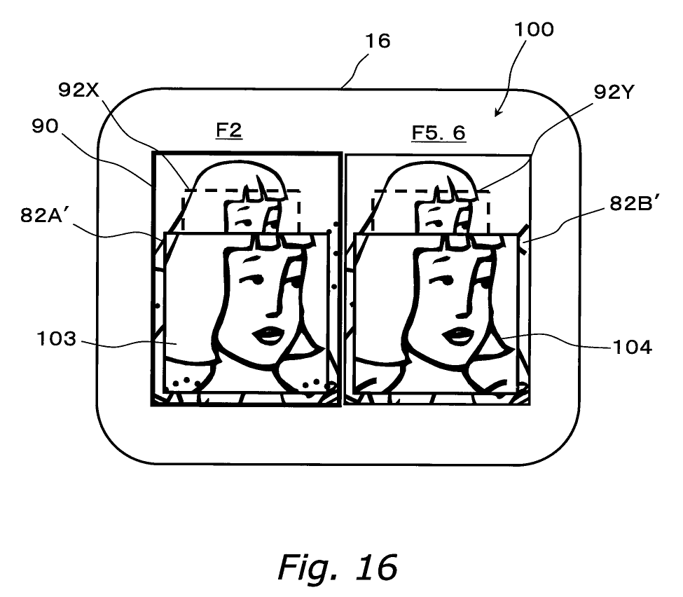

The image display control component 15 displays enlarged images of the reference image and the comparative image along with the reference image and the comparative image on the liquid crystal monitor 16 (step S109). FIG. 16 is a display example of enlarged display. The image display control component 15 displays an enlarged image 103 of the enlargement region of the reference image 82A′ (hereinafter referred to as the reference enlarged image) and an enlarged image 104 of the enlargement region of the comparative image 82B′ (hereinafter referred to as the comparative enlarged image) on the liquid crystal monitor 16, with these images overlapping the display of step S109 (FIG. 15).

The size of the reference enlarged image 103 and the comparative enlarged image 104 is constant, regardless of the size of the enlargement regions, for example. Also, the reference enlarged image 103 is displayed overlapping the reference image 82A′, and the comparative enlarged image 104 is displayed overlapping the comparative image 82B′. The reference enlarged image 103 and comparative enlarged image 104 are displayed side by side on the left and right. The enlargement cursor frames 91X and 91Y are displayed as enlargement region frames 92X and 92Y indicating the enlargement region, by a different display method (such as changing a solid line to a broken line). Also, the above-mentioned cursor frame 90 is displayed on one side of the display region of the liquid crystal monitor 16 so that either the reference image 82A′ or the comparative image 82B′ can be selected.

Thus, the degree of blurring of the background (the ocean) and the subject (a woman) on which the camera is focused an be easily compared by enlarged display.

2.8: Changing the Comparative Image in Enlarged Mode

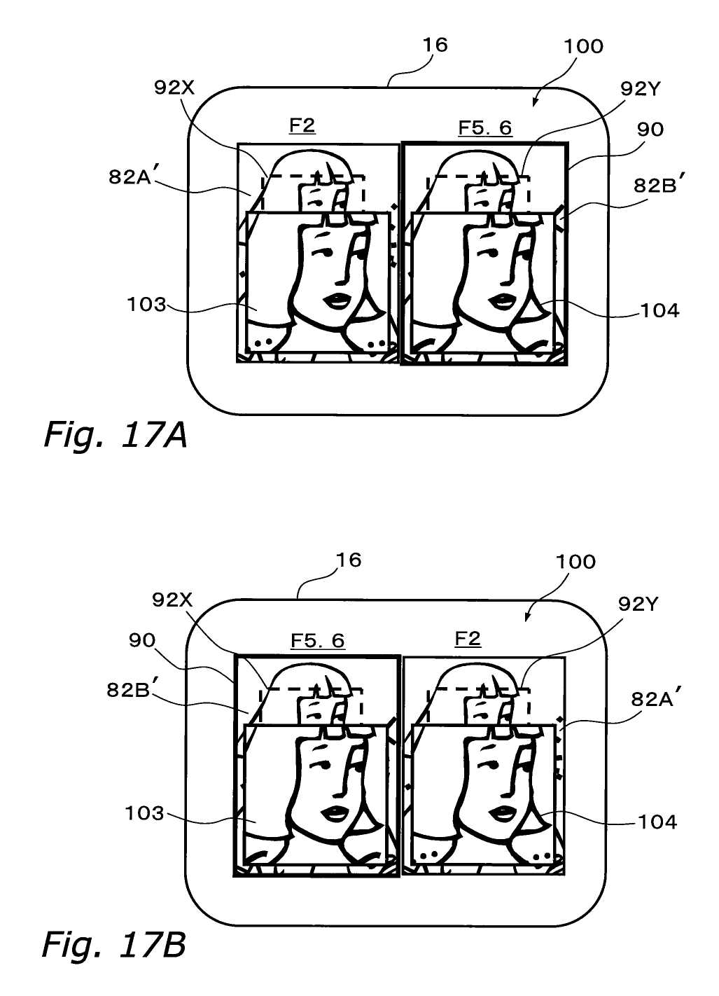

In an enlarged mode display state, if the user decides that the comparative image is preferable, and the comparative image is selected by the user, then the selected comparative image becomes the new reference image. The display conditions of enlarged mode are maintained even after the reference image has changed. This will be described through reference to the display examples in FIGS. 17A and 17B.

For example, the user moves the directional arrow key 73 to the left and right to line up the cursor frame 90 with the comparative image 82B′ (the display example shown in FIG. 17A). After this, when the set button 77 is pressed, the body microprocessor 12 determines that the comparative image 82B′ has been selected (step S110). In this case, the image display control component 15 displays the comparative image 82B′ on the left side of the display region of the liquid crystal monitor 16 as the new reference image 82B′ (step S111). The reference image 82A′ is displayed on the right side of the display region of the liquid crystal monitor 16 as the comparative image 82A′ (step S112). Also, in the case of enlarged mode, the enlargement region is maintained while the image display control component 15 displays the reference enlarged image 103 of the reference image 82B′ and the comparative enlarged image 104 of the comparative image 82A′ on the liquid crystal monitor 16 (steps S113 and S114).

Thus, with this embodiment, when the cursor frame 90 is used to select the comparative image, the selected comparative image is set to be the new reference image, and the comparative image and reference image are switched left to right. For example, the display example shown in FIG. 17A is switched to the display example shown in FIG. 17B.

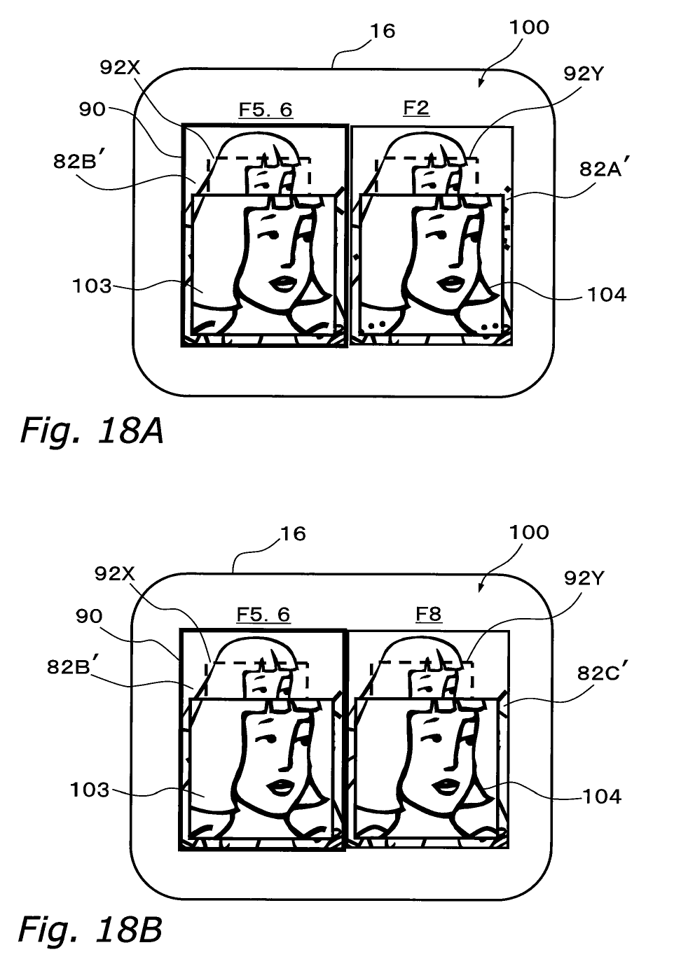

In an enlarged mode display state, when the user changes the comparative image, the display conditions of enlarged mode are maintained even after the comparative image has been changed. A display example will be described through reference to FIG. 18.

Also, in an enlarged mode display state, the user can select another image as the comparative image. For example, when the user turns the dial 78, the body microprocessor 12 determines that the comparative image has changed (step S115). The body microprocessor 12 selects as a new comparative image an image (such as the image 82C) other than the image 82B including the reference image 82B′ and the image 82A including the comparative image 82A′ current displayed, from among the series of images recorded to the folder 82. The image display control component 15 changes the image displayed on the right side of the display region of the liquid crystal monitor 16 from the comparative image 82A′ prior to selection to part of the selected image 82C (comparative image 82C′), and display the comparative image 82C′ on the liquid crystal monitor 16 (step S112).

The enlarged mode display conditions here are maintained. More specifically, the body microprocessor 12 stores the position and size of the enlargement region in the comparative image 82A′ prior to change. The image display control component 15 displays a portion of the comparative image 82C′ after the change of the comparative image, which is the same as the enlargement region stored in the body microprocessor 12, at the same magnification, as the comparative enlarged image 104 on the liquid crystal monitor 16 (steps S113 and S114). Thus, the image display control component 15 changes the comparative enlarged image 104 in synchronization with the change of the comparative image.

If there is no comparative image change input, the body microprocessor 12 determines whether or not the optimal image has been selected (step S116). More specifically, the set button 77 is pressed in a state in which the cursor frame 90 is aligned with the reference image 82B′, that is, a state in which the reference image 82B′ is selected, whereupon the body microprocessor 12 determines that the reference image 82B′ has been selected as the optimal image. The body microprocessor 12 then sets the selected reference image 82B′ as the optimal image.

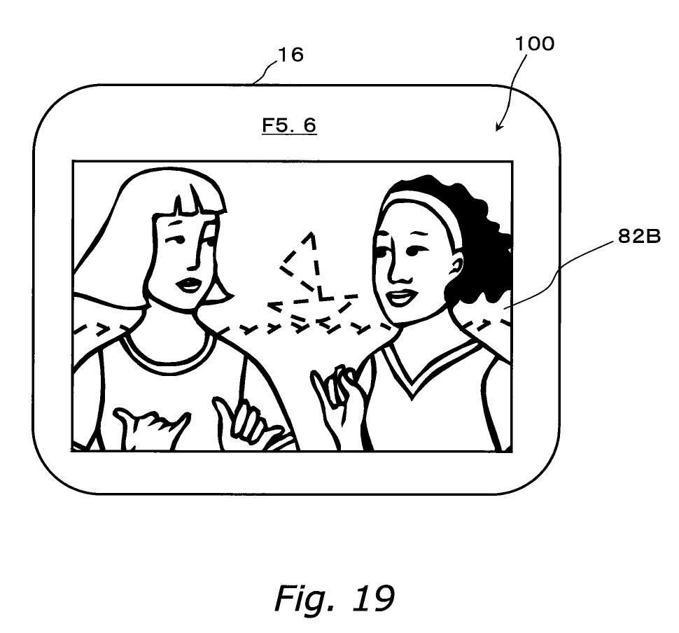

When the optimal image is set, the image display control component 15 displays on the liquid crystal monitor 16 the entire image 82B of F5.6 selected as the optimal image from among the series of images, as in the display example in FIG. 19 (step S117). The image display control component 15 performs processing that allows the optimal image to be distinguished from other images. More specifically, the image display control component 15 stores information indicating that this is the optimal image, and deletes the series of images other than the image selected as the optimal image, or moves the optimal image to a separate folder, or performs other such processing (step S117).

3: Features

The features of the camera system 200 are as follows.

(1)

With this camera system 200, the same region of a plurality of images (the left half of each image in the embodiment discussed above) acquired under different photography conditions can be displayed side by side as a reference image and a comparative image. This allows the corresponding portions of a plurality of images acquired under different photography conditions to be compared substantially adjacent to one another, and this improves convenience in the comparison of images.

(2)

Enlarged images of the same region of a reference image and a comparative image can be displayed side by side. This allows the fine details of a plurality of images acquired under different photography conditions to be compared.

(3)

When a comparative image is changed in a state in which an enlarged image is displayed (enlarged mode), the changed comparative image is displayed as an enlarged image with the same position and size as before the change. This makes operation more convenient for the user.

(4)

The depth of field reviewing mode allows the optimal aperture value to be set while comparing the actual image of the subject prior to capturing the image. Also, since the aperture is set to the desired value during image capture, the user can capture an image at the optimal aperture value. Also, a plurality of images can be captured at the set aperture value, for example, which means that there is greater photographic freedom.

### Other Embodiments

The specific constitution of the present invention is not limited to the above-mentioned embodiment, and various modifications and changes are possible without departing from the gist of the invention.

(1)

A single-lens reflex camera was described in the above embodiment, but the present invention is not limited to a single-lens reflex camera, and may also be applied to other camera systems, such as a compact camera.

(2)

The method for determining whether the optimal image has been selected (step S117) may be such that if all the images in the folder 82 have been compared at least once, the body microprocessor 12 determines that the last reference image has been selected as the optimal image.

(3)

Upon completion of the depth of field reviewing mode, the series of images recorded to the folder 82 may be deleted.

(4)

In the above embodiment, selection and setting of the enlargement region were carried out by the user, but the enlargement region can be selected by other methods. For instance, the configuration may be such that a region including a large boundary region with a different distance to the subject is detected, and the reference frame is automatically set on the basis of this detection result. More specifically, for example, the Df amount is detected by the focus detection unit 5 at a plurality of points in a single image. On the basis of these Df amounts, the body microprocessor 12 detects the region with the greatest difference in Df amounts within a single image (the greatest difference between focused and unfocused regions). The region with the greatest differential in Df amounts is automatically set as the reference frame.

In this case, since the reference frame is automatically set by the above method, the reference image best suited to comparison can be quickly selected. This further enhances convenience of comparison.

(5)

In the above embodiment, the aperture ring 40 mounted on the interchangeable lens unit 2 was used to update the aperture value. However, the configuration may be such that the aperture value is updated using a dial, button, or other such control mounted on the camera main body 1 instead of using the aperture ring 40. Also, the control mounted on the camera main body 1 need not be one intended [solely] for the purpose of updating the aperture value, and may instead be a control that is also used for some other purpose.

(6)

In the above embodiment, the image displayed on the liquid crystal monitor 16 was acquired by the imaging sensor 11, but it is also possible to use another imaging sensor disposed in the viewfinder optical system. In this case, there is no need to retract the quick return mirror 4 from the optical path X in monitor photography mode. Also, the configuration and disposition of the quick return mirror 4, the viewfinder optical system 19, and so forth are not limited to those discussed above.

(7)

The configuration may, for example, be such that in a reproduction mode in which the captured image is reproduced, images captured at different aperture values are displayed side by side to the left and right on the liquid crystal monitor 16. This gives the user a sensory feel for the correlation between the aperture value and the captured images, and can be referred to in subsequent imaging.

(8)

In the above embodiment, the aperture value was changed as the photography condition, but the photography condition is not limited to this. For instance, the images that are compared may be a plurality of images captured at different shutter speeds. In this case, in reproduction mode two images are displayed side by side with one image inverted. This makes it easier and more convenient for a plurality of images captured at different shutter speeds to be compared.

(9)

In the above embodiment, a single-lens reflex camera was used as an example of the camera system 200, but embodiments of the camera system 200 are not limited to this. For example, this camera system 200 can also be applied to a compact camera or the like. In particular, when the camera system 200 is applied to a compact camera having a large imaging element, the position, range, and so forth of the enlargement cursor frames 91X and 91Y can be more freely selected, so this camera system 200 is advantageous.

(10)

In the above embodiment, when the comparative image was selected as a new reference image as in the display example in FIG. 17, the display positions of the comparative image and reference image were switched, so that the new reference image was displayed on the same left side as before the change, but it may be determined that the image highlighted by the cursor frame 90 is the reference frame, and the display position need not be changed. In this case, when the dial 78 is turned and the comparative image is changed to another image, the image not highlighted by the cursor frame 90 may be the one that is changed.

(11)

In the above embodiment, the reference image and comparative image were displayed side by side to the left and right, but it is also possible for the reference image and comparative image to be above one another, or diagonally next to each other. Here again, the same effects as in the above-mentioned embodiment are obtained.

(12)

In the above embodiment, two images (a reference image and a comparative image) captured under different photography conditions were displayed on the liquid crystal monitor 16, but three or more images (a reference image, a first comparative image, a second comparative image, . . . ) captured under different photography conditions may also be displayed.

(13)

The coordinate axes, directions, and so forth used in the above description do not limit the usage state of the present invention.

### GENERAL INTERPRETATION OF TERMS

In understanding the scope of the present invention, the term “configured” as used herein to describe a component, section or part of a device includes hardware and/or software that is constructed and/or programmed to carry out the desired function.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member,” or “element” when used in the singular can have the dual meaning of a single part or a plurality of parts.

Terms that are expressed as “means-plus function” in the claims should include any structure that can be utilized to carry out the function of that part of the present invention. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A camera system, comprising:
an imaging optical system configured to form an optical image of a subject;
an imaging component configured to convert the optical image into an image signal and acquiring an image of the subject;
a display component with which a plurality of the images acquired by the imaging component can be displayed side by side; and
a display control component configured to control the display component to display as a reference image part of a first image acquired by the imaging component, and the display control component configured to control the display component to display as a comparative image part of a second image acquired by the imaging component under a different photography condition from that of the first image, the position of the comparative image in the second image being the same as the position of the reference image in the first image, the comparative image being proximate to the reference image on the display component.

2. The camera system according to claim 1, wherein
the display control component is arranged to control the display component to display a first enlarged image and a second enlarged image, the first enlarged image being obtained by enlarging part of the reference image and the second enlarged image being obtained by enlarging part of the comparative image, the position of the second enlarged image in the comparative image being the same as the first enlarged image in the reference image.

3. The camera system according to claim 2, wherein
the display control component is arranged to control the display component to display as a comparative image part of a third image acquired by the imaging component under a different photography condition from that of the first image and the second image, the position of the comparative image in the third image being the same as the position of the reference image in the first image.

4. The camera system according to claim 3, wherein
the display control component arranged to control the display component to display on the display component a third enlarged image that is part of the third image when the first enlarged image is being displayed, and the position of the third enlarged image in the comparative image is the same as the position of the first enlarged image in the reference image.

5. The camera system according to claim 4, wherein
the display control component is arranged to control the display component to display the photography condition of the reference image and the photography condition of the comparative image on the display component.

6. The camera system according to claim 5, wherein
the photography condition is an aperture value.

7. The camera system according to claim 1, wherein
the display control component is arranged to control the display component to display as a comparative image part of a third image acquired by the imaging component under a different photography condition from that of the first image and the second image, the position of the comparative image in the third image being the same as the position of the reference image in the first image.

8. The camera system according to claim 7, wherein
the display control component arranged to control the display component to display on the display component a third enlarged image that is part of the third image when the first enlarged image is being displayed, and the position of the third enlarged image in the comparative image is the same as the position of the first enlarged image in the reference image.

9. The camera system according to claim 8, wherein
the display control component is arranged to control the display component to display the photography condition of the reference image and the photography condition of the comparative image on the display component.

10. The camera system according to claim 9, wherein
the photography condition is an aperture value.

11. The camera system according to claim 1, wherein
the display control component is arranged to control the display component to display the photography condition of the reference image and the photography condition of the comparative image on the display component.

12. The camera system according to claim 11, wherein
the photography condition is an aperture value.

13. The camera system according to claim 1, wherein
the photography condition is an aperture value.
